(19) United States
(12) Patent Application Publication
(10) Pub. No.: US 2012/0096925 A1
(43) Pub. Date: Apr. 26, 2012

(54) METHOD AND ANALYZER FOR DETERMINING THE CONTENT OF CARBON-CONTAINING PARTICLES FILTERED FROM AN AIR STREAM

(75) Inventors: Anthony D.A. Hansen, Berkeley, CA (US); Jeffrey R. Blair, San Francisco, CA (US)

(73) Assignee: MAGEE SCIENTIFIC CORPORATION, Berkeley, CA (US)

(21) Appl. No.: 13/279,037

(22) Filed: Oct. 21, 2011

Related U.S. Application Data
(60) Provisional application No. 61/406,013, filed on Oct. 22, 2010.

(51) Int. Cl. G01N 1/44

(52) U.S. Cl. 73/28.04

(57) ABSTRACT

An improved analyzer and method of analyzing the content of carbon-containing particles in samples filtered from an air stream is presented. The air stream may be, for example and without limitation, ambient air impacted by pollution; air breathed in an occupational situation such as the atmosphere in a factory or mine; or a combustion exhaust stream such as an engine tailpipe, a chimney, or a smoke plume. The analyzer may operate without the use of bottled gases, such as unfiltered air, and may be operated to provide a very large dynamic range.

### CROSS-REFERENCE TO RELATED APPLICATIONS

This application claims the benefit of U.S. Provisional Application No. 61/406,013, filed Oct. 22, 2010, the entire contents of which are hereby incorporated by reference herein and made part of this specification.

### BACKGROUND OF THE INVENTION

1. Field of the Invention

The present invention generally relates to sampling particles in an air stream, and more particularly to a method and system for determining the content of carbon-containing particles filtered from an air stream.

2. Discussion of the Background

Combustion processes typically produce gaseous and particulate species as by-products. The combustion of carbon-containing fuels, such as petroleum products, bio-derived liquid fuels, coal, and biomass such as wood, all release carbonaceous particles in their exhaust streams. These particles are implicated in local, regional and global climate change, due to their ability to absorb sunlight and change the properties of clouds, and are associated with adverse human health impacts arising from their inhalation and deposition in the lungs and body tissues.

It is necessary and desirable to be able to measure the concentration of carbon-containing particles in air to provide information required to study particles and to support regulations intended to protect human health and minimize the possibilities of climate change. Technologies based on measurements of optical absorption of particles in streams of air are able to quantify the content of “black” or “elemental” carbon particles. However, a much greater content of carbon is usually found in the form of organic compounds that do not absorb visible light. These compounds include almost every carbon-containing molecule known, spanning an extremely wide range of physical properties such as electromagnetic absorption, scattering, polarization and dispersion (including light from infra-red to ultra-violet, and continuing into x-rays), ionizability, volatility, and all other analytical attributes. Consequently, it is neither possible nor practical to individually identify the myriad of carbonaceous compounds in a typical sample collected from an exhaust stream or the atmosphere.

Prior art instruments may determine the carbon content of a sample of material by total combustion of the sample in an oxygen atmosphere, followed by measurement of the CO₂ produced. Instruments that operate on this principle accept the sample—usually of milligram quantity—in a sealed container and heat the sample in a flowing stream of a purified oxidizing atmosphere. The totality of CO₂ is determined by a gas analyzer, from which the totality of carbon in the original sample may be deduced. This type of instrument detects a small concentration of CO₂ in the flowing stream, relative to the zero baseline in the purified supply.

Other prior art instruments perform a similar analysis, but in a continuous manner while the sample temperature is gradually increased in a flowing gas stream. In this way, it is believed that the evaporation, desorption, decomposition or combustion of the carbon-containing compounds at increasing temperatures may indicate the nature of the material being heated. However, there is considerable debate as to the degree to which the thermal decomposition of a material may be uniquely representative of its original composition. Due to the very small rate of release of carbonaceous compounds to the flowing gas stream, this requires that the sample be heated in a flowing stream of carrier gas of extremely precise composition and purity, and that the response of the system's detectors be stable over the duration of the progressive temperature ramp.

Both of the above prior art analytical methods require the ability to detect a very small concentration of CO₂ in a flowing gas stream relative to a baseline having a CO₂ concentration that is very close to zero. This requirement is due to the very small quantities of carbon per unit time released into the flowing carrier gas stream. There is thus a strong requirement as to the purity of the flowing carrier gas streams required and on the sensitivity and stability of the CO₂ detector that must be used.

Prior art analytical methods thus typically require specialized carrier gas streams for the correct operation of the instrument. These gases are usually supplied in high-pressure cylinders. Sophisticated laboratories in highly-developed countries can obtain these gases relatively readily. However, this requirement is a serious logistical problem for both routine field monitoring operations anywhere in the world, for research applications in many countries in which specialty gases are not readily available, for any location supplied primarily by air freight, or for which the transportation of high-pressure gas cylinders is potentially hazardous.

Thus there is a need in the art for a method and apparatus that permits for the accurate measurement of the total amount of carbon in a sample obtained from a flowing air stream. Such a method and apparatus should be simple to use, provide accurate measurements of very small quantities of carbon containing particles, and require no special gases for the analysis.

### BRIEF SUMMARY OF THE INVENTION

The present invention overcomes the disadvantages of prior art by providing a system and method to determine the total content of carbon in a sample, including both “black” (or “elemental”) as well as “organic” forms of carbon in particles. The sample may be obtained, for example and without limitation, by filtering carbon-containing particles from a passing air stream, such as ambient air, air encountered in occupational situations, or combustion exhaust streams such as an engine exhaust tailpipe, a chimney, or a smoke plume.

The disadvantages of the prior art are overcome, in certain embodiments of the present invention by 1) providing a system or method for rapidly analyzing the total content of carbon-containing compounds in a sample filtered from a flowing stream of ambient air, and/or 2) a system that produces CO₂ from a sample air stream in a concentration that is large enough to be readily detected by a detector of modest specifications and without the need for specialty high-purity gases.

Various embodiments may be used to analyze integral samples previously collected and inserted into the apparatus (“laboratory analyzer mode”), or to analyze the continuous filtration of an air stream, collecting carbonaceous particles on an internal filter, and performing a periodic analysis to determine the instantaneous or recent concentration of carbon-containing particles in the sampled air stream (“field analyzer mode”).

One advantage of certain embodiments is the rapid analysis of the total carbonaceous content of a sample without the need to apply any assumptions as to the separation of the analyte into different arbitrary fractions. Other advantages of certain embodiments is that the system may be operated with ambient air, eliminating the necessity of the supporting infrastructure required for specialized gases of precise composition, that the sample stream need not be conditioned, diluted or dehumidified before analysis, and that the performance of the system may be independent of the alignment of any component, or the stability of any baseline response of any component of the analyzer.

Another advantage of certain other embodiments is that the system analyzes samples containing microgram levels of carbon content, yet does not require specialized or pure gases to serve as carriers to transport the products of combustion to the detector. This permits room ambient air to be used as the carrier gas.

Yet another advantage of certain embodiments is that none of the components of the system require precise alignment, registration or positioning. This is a very substantial advantage for use in “real world” laboratories and field measurement stations. If the system must be disassembled for any reason such as servicing or cleaning, it is highly advantageous that it can be re-assembled to full operational performance by local personnel whose level of training and familiarity may be variable and unknown. It is an advantage that is possible to construct such a system without any optical elements, for the above reason.

Certain embodiments provide a method of determining the amount of carbon in a sample of particles. The method includes: collecting the particles from a first gas; heating the collected particles in the presence of a second gas to generate a sample; providing the sample to an analyzer capable of measuring the carbon content of the sample, where the second gas includes carbon dioxide detectable by the analyzer; and providing an output from the analyzer indicative of the amount of carbon in the collected particles.

Certain other embodiments provide a method of determining the amount of carbon in a sample of particles contained in a gas sample. The method includes: collecting the particles from a first gas; heating the collected particles in the presence of a second gas to generate a gaseous sample, where the second gas is unfiltered air or the first gas; providing the sample to an analyzer capable of measuring the carbon content of the sample; and providing an output from the analyzer indicative of the amount of carbon in the collected particles.

Yet certain other embodiments provide a method of determining the amount of carbon in a sample of particles. The method includes: collecting the particles from a first gas; heating the collected particles in the presence of a second gas to generate a sample; providing the sample to an analyzer in less than 15 seconds, where the analyzer is capable of measuring the carbon content of the sample; and providing an output from the analyzer indicative of the amount of carbon in the collected particles.

Yet other embodiments provide a method of determining the amount of carbon in a sample of particles. The method includes: collecting the particles from a first gas; heating the collected particles in the presence of a second gas to generate a sample; varying the flow rate of the second gas according to the total amount of collected particles; providing the sample to an analyzer capable of measuring the carbon content of the sample; and providing an output from the analyzer indicative of the amount of carbon in the collected particles.

Certain embodiments provide an apparatus for determining the amount of carbon in a sample of particles. The apparatus includes: a filter for collecting particles; a pump to provide a flow of unfiltered air to the collected particles; a heater to heat the collected particles such that the particles combust in the unfiltered air; a carbon dioxide detector to measure carbon dioxide derived from the combusted particles; and a computer programmed to utilize the carbon dioxide detector output to provide an indication of the carbon content of the collected particles.

Certain other embodiments provide an apparatus to determine the content of carbon-containing particles in an air stream. The apparatus includes: means to combust the particles in the presence of unfiltered air; and a carbon-dioxide sensor to measure a concentration of carbon-dioxide derived from the combusted particles.

These features together with the various ancillary provisions and features which will become apparent to those skilled in the art from the following detailed description, are attained by the method and analyzer for determining the content of carbon-containing particles filtered from an air stream of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a perspective view of a first embodiment of a particle analysis system in a first configuration;

FIG. 1A is a side view of the configuration of FIG. 1;

FIG. 1B is a top view 1B-1B of FIG. 1;

FIG. 1C is a side view of the particle analysis system in a second configuration;

FIG. 1D is a top view of the configuration of FIG. 1C;

FIG. 1E is a sectional view 1E-1E of FIG. 1D showing the sample chamber and heater;

FIG. 1F is a sectional view illustrating one embodiment of the components of a sample chamber FIG. 1A;

FIG. 2A is a side view of a second embodiment of a particle analysis system in a first configuration;

FIG. 2B is a top view of the configuration of FIG. 2A;

FIG. 2C is a side view of the a particle analysis system in a second configuration;

FIG. 2D is a top view of the configuration of FIG. 2C;

FIG. 3 is an alternative embodiment of a gas inlet of a particle analysis system;

FIG. 4 is a graph of a calculation of the predicted peak CO2 detected versus sampling and analysis conditions; and

FIG. 5 is a graph illustrating the operation of a particle analysis system.

Reference symbols are used in the Figures to indicate certain components, aspects or features shown therein, with reference symbols common to more than one Figure indicating like components, aspects or features shown therein.

### DETAILED DESCRIPTION OF THE INVENTION

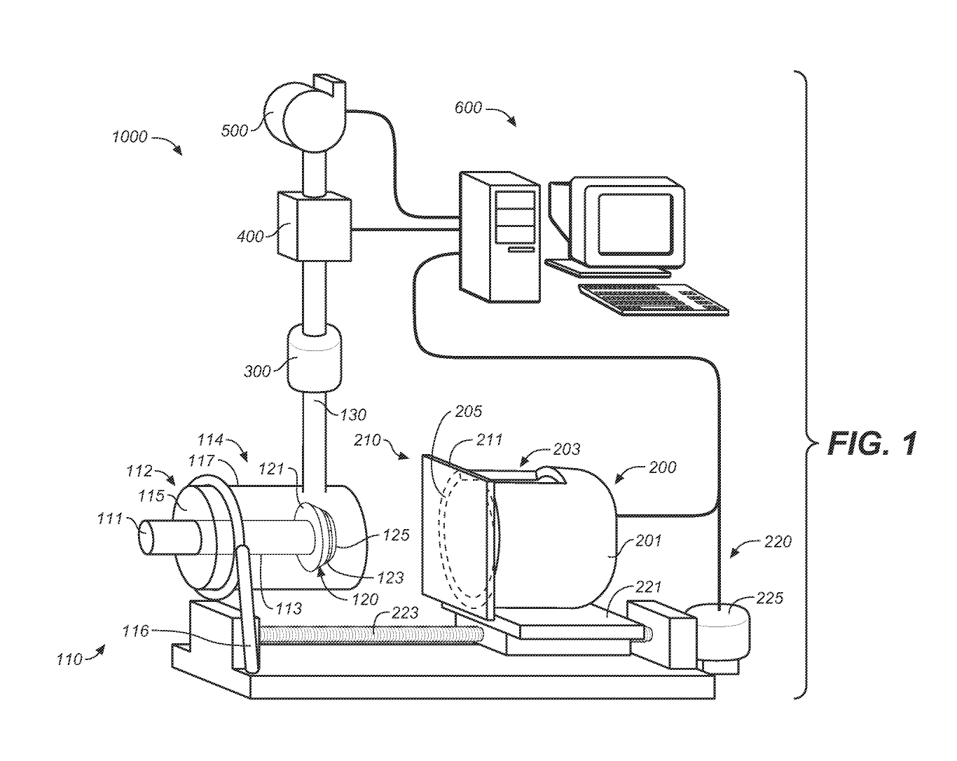

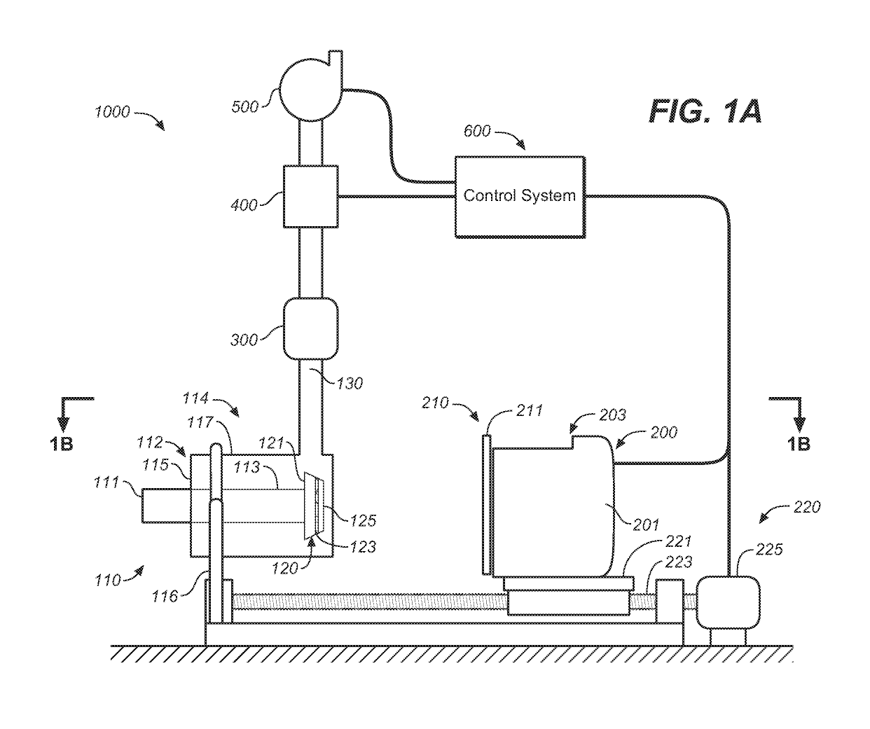

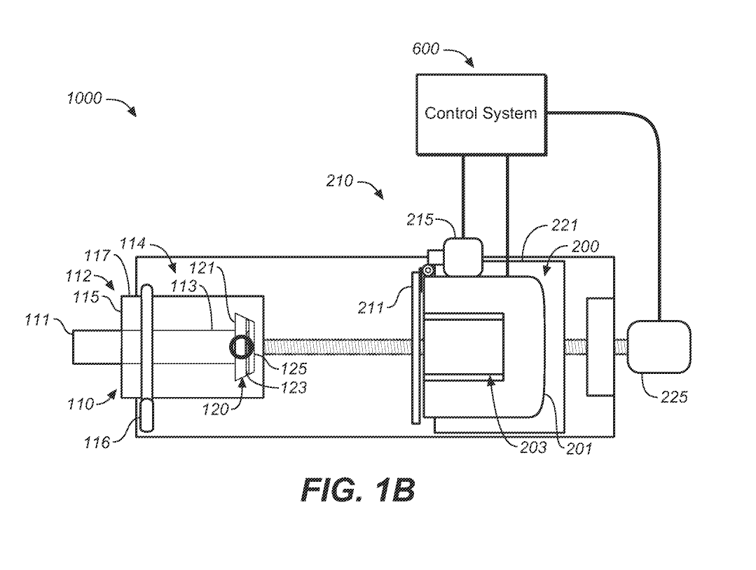

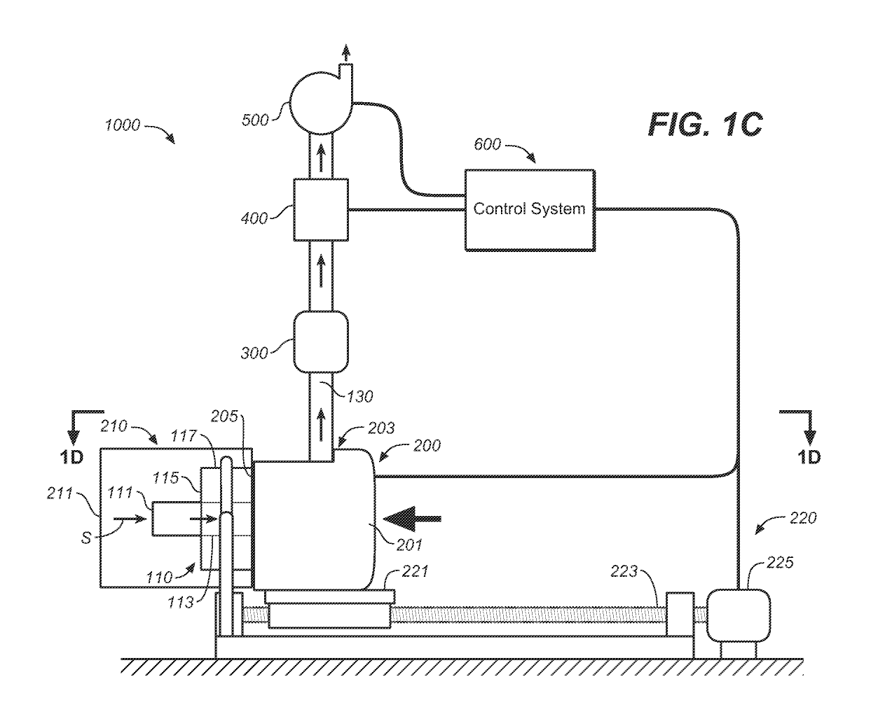

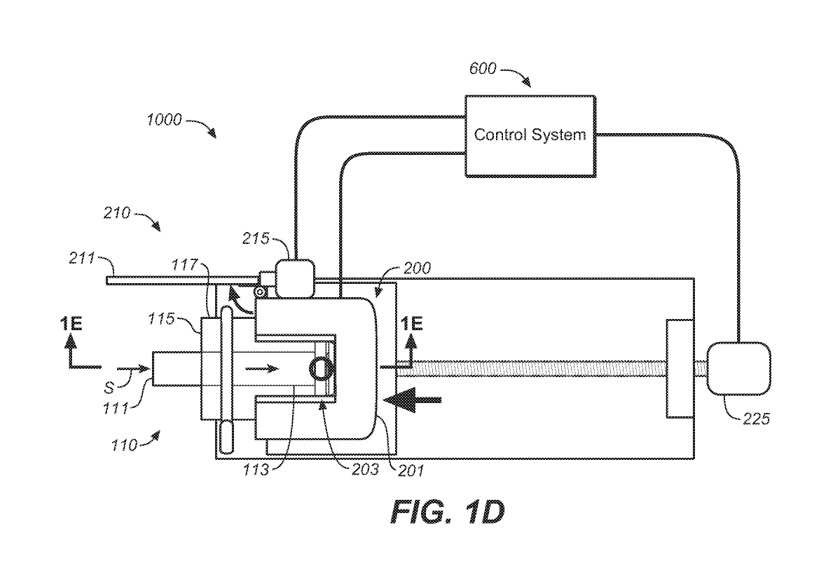

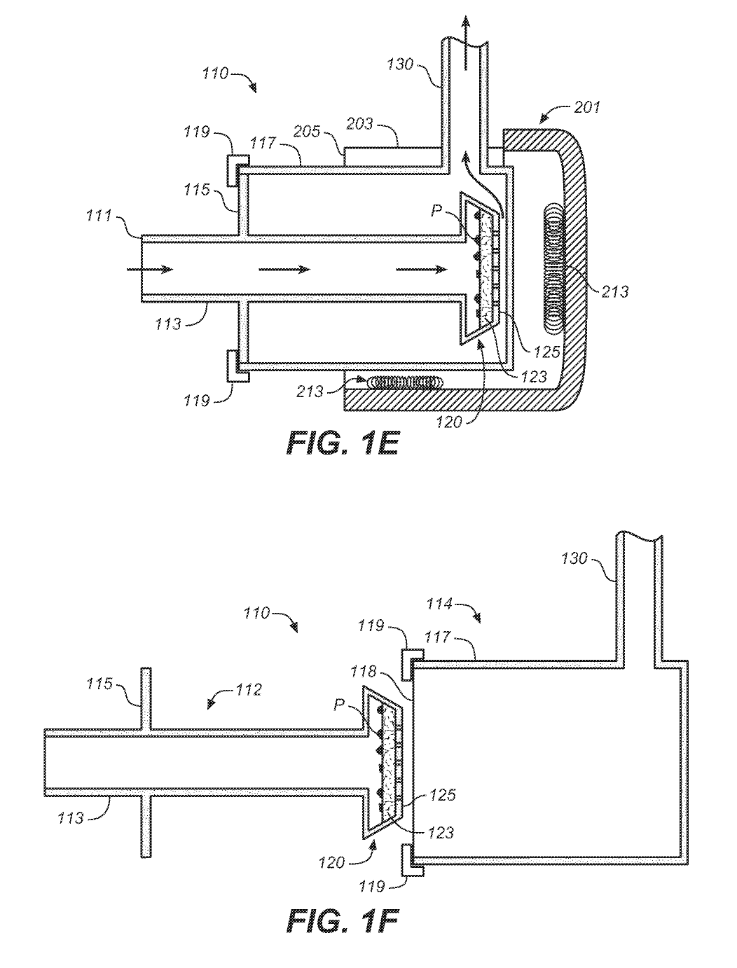

A first embodiment of a particle analysis system 1000 is illustrated in a first configuration in the perspective view of FIG. 1, side view FIG. 1A and the top view FIG. 1B.

Particle analysis system 1000 includes a sample chamber 110, a heater 200, a carbon dioxide detector 400, a suction pump 500, and a control system 600 that controls the operation of the system and generates an output. Particle analysis system 1000 may also include an optional catalyst 300. Particle analysis system 1000 is provided with particulates P on a filter 123 within sample holder 120, and includes an opening 111 to accept a gas into the sample chamber, and a tube 130 to carry gases through the optional catalyst 300, carbon dioxide detector 400, as drawn by suction pump 500.

The details of one embodiment of sample chamber 110 are illustrated in the longitudinal sectional view of FIG. 1F, which illustrates that the sample chamber may include an inner portion 112 that is removable from an outer portion 114. Inner portion 112 includes a tube 113 having an inlet 111 at one end and sample holder 120 at the opposing end and a flange 115. Sample holder 120 further includes filter 123 and a sintered or otherwise porous end 125.

Filter 123 is preferably a filter that can collect particles as small as 0.1 micron, than can withstand the temperatures resulting from heating and combustion the particles, that in and of itself does not release carbon containing gases. As an example, filter 123 may be, without limitation, a quartz fiber filter.

Outer portion 114 includes an opening 118 in a chamber 117, supported by a bracket 116, and an outlet tube 130. In one embodiment, filter 123 is from 10 mm to 30 mm in diameter. In another embodiment, filter 123 is approximately 20 mm in diameter. It is preferable that the internal volume of sample chamber 110 be as small is possible. In certain embodiments, sample chamber 110 has a volume of from 2 mL to 50 mL. In one embodiment, the internal volume of sample chamber 110 is 10 mL.

Sample chamber 110 also includes several clamps or clips 119. Flange 115 of inner portion 112 seats against opening 118 of outer portion 114, and clips 119 are used to provide an air-tight seal. This construction permits the cleaning of filter 123 or the replacement of the entire inner portion, including the filter.

Heater 200 provides for the rapid heating of particulates P on filter 123. In one embodiment, heater 200 includes a furnace 201 that is mounted on a platform 221 of a translation stage 220 having a motor 225 that drives a lead screw 223. Furnace 201 has a side slot 203, an opening 205 to an interior that can be heated to a high temperature. Heater 200 further includes a movable shield 210 that includes a panel 211 attached to platform 221 that may be moved by a motor 215. In one embodiment, panel 211 is a heat shield that may be opened or closed to allow or block radiative heat transfer from furnace 201. In first configuration, furnace 201 may be heated by electric power provided by control system 600, and opening 205 is covered by panel 211 to prevent the heating of sample holder 120.

In an alternative embodiment, heater 200 may be a laser heating system that provides an intensity radiation heating of particulates P on filter 123.

Optional catalyst 300 ensures the complete conversion to carbon dioxide of all carbon-containing compounds released from the sample. This catalyst may take the form of a small heated element of special materials inserted into the flowing gas stream.

Carbon dioxide sensor 400 measures the concentration of CO₂ provided from sample chamber 120. Carbon dioxide sensor 400 is specifically of a design and type that responds quickly to changes in CO₂ concentration. Suitable sensors are offered by several manufacturers, such as, for example and without limitation, ‘Alphasense’ model IRC-A1 (see http://www.alphasense.com/alphasense_sensors/ndir_sensors.html); ‘Valtronics’ model 2015SPI-1 (see http://www.val-tronics.com/downloads/specsheets/2015S-1.pdf); ‘LumaSense’ model 6500 (see http://www.lumasenseinc.com/uploads/Andros/pdfs/Datasheet_{—}6500Series.pdf).

Suction pump 500 may be operated to draw gas into inlet 111 and through sample chamber 110, sample chamber 120, catalyst 300, and carbon dioxide detector 400. Suction pump 500 includes a flow sensor and control system such that the flow rate may be specified and then automatically maintained. Suction pump 500 is specifically of a design and type that can be started and stopped quickly. Examples of such a pump include, but are not limited to, a Thomas model G6/01-K-EB12 (manufactured by Gardener Denver, Inc, Wayne, Pa.), a Schwarzer model SP-135-FZ (manufactured by Schwarzer Precision GmbH+Co. KGa, Essen, Germany), or a Namiki model S-3038 ((manufactured by Namiki, Tokyo, Japan). It is preferred, but not required, that the air flow rate is in the range of 50 mLPM to 500 mLPM.

Control system 600 controls particle analysis system 1000 and analyzes particles P to provide an indication of the mass, number of moles, or concentration, or some other indication, carbon that was present in the particles. Control system 600 may include one or more pre-programmed or programmable processors and input and output interfaces for furnace 201, motors 215 and 225, pumps 500 and/or 700, and carbon dioxide detector 400. Control system 600 may also include a display, input devices, means for receiving programming or providing data including, but not limited to, USB connectors or wired or wireless interface devices.

FIG. 1C is a side view of particle analysis system 1000 in a second configuration and FIG. 1D is a top view of the configuration of FIG. 1C. In the second configuration, panel 211 is moved to expose opening 205, and furnace 201 is moved towards sample chamber 110, as indicated by the vertical arrows in FIGS. 1C and 1D.

In one embodiment, control system 600 may move particle analysis system 1000 from the first configuration of FIGS. 1A and 1B to the second, analysis configuration of FIGS. 1C and 1D. Thus, for example, control system 600 provides power to heat furnace 201, operates motor 215 to retract insulating heat-shield panel 211 from opening 205, and operates motor 225 to rapidly move furnace 201 so as to completely enclose the sample chamber 110. Control system may further actuate suction pump 500 to draw an analytical stream S flow into the sample chamber 110, over particulates P in sample chamber 120, through optional catalyst 300, and through carbon dioxide detector 400.

FIG. 1E is a sectional view of sample chamber 110 and heater 200 in the second configuration of FIGS. 1C and 1D. Furnace 201 has an interior shape of a closed hollow cylinder or cup with opening 205. Furnace 201 also includes a plurality of heating elements 213 on all interior surfaces of the furnace that are operated by control system 600. The interior of furnace 201 may thus be raised to a high temperature in advance and maintained at that temperature by providing power to elements 213. The interior temperature of furnace 201 may be, for example and without limitation, in the range of 600° C. to 800° C. It is necessary that the interior temperature of furnace 201 be sufficiently high to provide rapid heating of the chamber 110 by thermal radiation. Slot 203 permits accommodation of the side tube 130 when furnace 201 is moved over sample chamber 110, as in the second configuration of FIGS. 1C and 1D.

As indicated by the arrows, in FIGS. 1C and 1E, sample chamber 110 provides a flow passageway through opening 111, along tube 113, through filter 123 that been used to collect particulates P, and end 125, and then out of the sample chamber though outlet 130. FIG. 1E also shows a plurality of heating elements 213 that are powered by control system 600.

In one embodiment, particulates P on filter 123 are rapidly heated by furnace 201 and combust in the carrier gas stream S as shown in FIGS. 1C and 1D. The combusted gases then flow through optional catalyst 300 (to ensure complete conversion to CO₂), and then flow through carbon dioxide detector 400, which provides a signal to control system 600, and which may be used to integrate the signal over time and provide an indication of the total carbon content of the particulates.

Heater 200 may thus rapidly heat particulates P and may, for example and without limitation, combust the particulates and convert them into more volatile materials, such as a gas, for measurement by carbon dioxide detector 400. In certain embodiments, at least part of sample chamber 110 is designed for rapid heating of a sample contained on filter 123. Thus, for example and without limitation, all of sample chamber 110, except for filter 123, may be constructed of an optically transparent material, which may be, for example, quartz, to facilitate the heating of the filter by thermal radiation, as discussed subsequently.

The CO₂ concentration measured by carbon dioxide detector 400 may be converted to a mass of carbon content of the sample by calculations performed in the carbon dioxide detector or control system 600. Thus, for example, carbon dioxide detector 400 measures CO₂ concentration over time, C(t), in a flow rate of air of F. Also, carbon dioxide detector 400 may also measure a background concentration, C₀, before or after the measurement, or may take readings and combine them to get an average background concentration. Integrating C(t) signal over the heating or combustion duration, T, and using the conversion of 1 ppm of CO₂ in air is 535.1 ng of carbon per liter under ‘standard’ conditions of temperature and pressure gives the mass of carbon as:

$$M / ( ng C ) = \frac{F / ( L \text{/} sec )}{535.1 ( ppm {CO}_{2} / ng C / L )} {\int }_{T [ se c ]} \{ C ( t ) - {C}_{o} \} / ( ppm {CO}_{2} ) d t$$

Thus, for example, the combustion of 1 μg of carbon into CO₂ which is added uniformly over a period of 0.1 minute to an air stream flowing at a rate of 50 mLPM will result in an increase in CO₂ concentration of 374 ppm during this period. This calculation, or other calculations for the conversion of the output of carbon dioxide detector 400 to a CO₂ concentration may be carried out by control system 600.

It is expected that complete combustion of the particulates would occur in a relatively short amount of time which could be less than 1 minute, less than 45 second, less than 30 seconds, or less than 15 seconds.

In one embodiment, carrier gas stream S is ambient air. In another embodiment, carrier gas stream S is unfiltered air. Specifically, there is no requirement that carbon containing or other impurity gases are excluded, or that their concentration is known or otherwise limited in carrier gas stream S.

In certain embodiments, the internal volume of sample chamber 110 is minimized as much as possible to reduce dilution of the CO₂ generated by combustion of the particulates. In certain other embodiments, sample chamber 110 is fabricated of material such as quartz glass, so that radiant heat transfer from furnace 201 can rapidly transmit energy to particulates P, in order to heat it, and the furnace is movable such that it can raise the temperature of particulates P from room temperature to many hundred degrees Celsius, as required for combustion, within a few seconds. Since there is no exact temperature requirement of furnace 201, other than it need be sufficiently hot to rapidly transmit radiant heat to the sample, its exact temperature is not critical. This permits the furnace to be controlled by a simple thermostat, and eliminates the need for complex temperature monitoring and control.

In other embodiments, furnace 201 is insulated to require relatively little consumption of electrical power, thereby permitting particle analysis system 1000 to operate from normal electrical supplies.

Particle analysis system 1000 does not require the precise alignment, registration or positioning of the various components. This is a very substantial advantage for use in “real world” laboratories and field measurement stations. If the system must be disassembled for any reason such as servicing or cleaning, it can be easily re-assembled to full operational performance.

In one embodiment, particle analysis system 1000 may be used for the analysis of previously-collected samples, and may thus be referred to as being operated in a “laboratory mode.” In the laboratory mode, inner portion 112 is removable, and may be used in the field to collect particles P on filter 123 by placing the inner portion in an apparatus including an outer portion 114 and pump (which may be a pump similar to pump 500, or some other pump). The time over which the particulates P are collected, and the flow rate of gas containing the particulates, may be noted and may be used for analysis of the results in article analysis system 1000.

With a particulate sample thus obtained, inner portion 112 may then be transferred to particle analysis system 1000 in the configuration of FIGS. 1A and 1B. Particle analysis system 1000 may then be placed in the configuration of FIGS. 1C and 1D, and a measurement of the carbon content of the particulates may be determined, as discussed above. When combustion of the particulates is complete, heater 200 is retracted, panel 211 is moved back into place, and sample chamber 110 is allowed to cool. Control system 600 may, at the completion of combustion, use the output of carbon dioxide detector 400 to provide an estimate of the particulate carbon concentration in the sampled gases as follows.

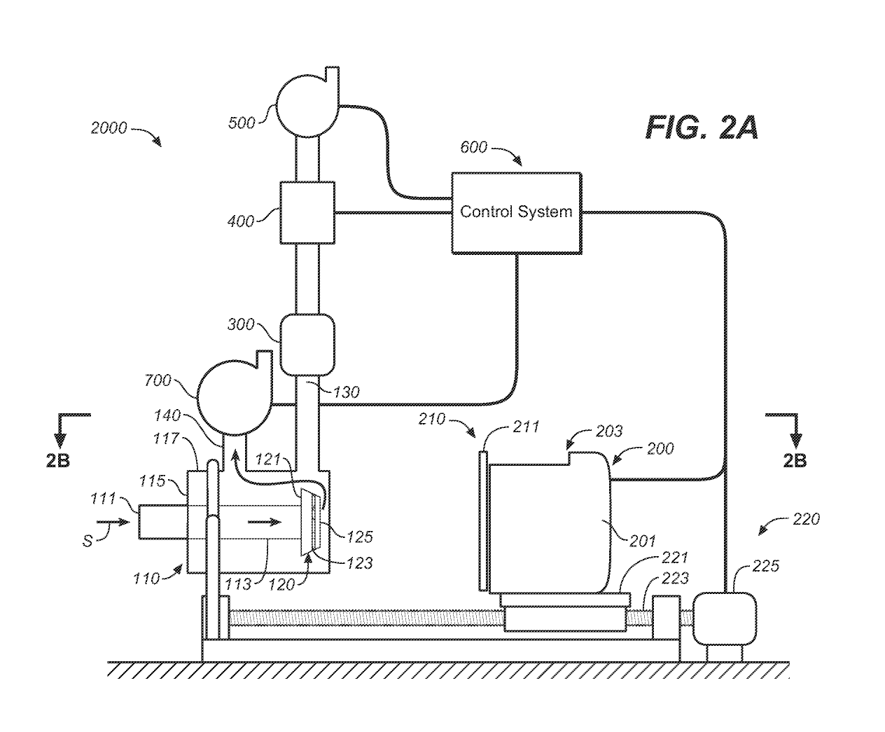

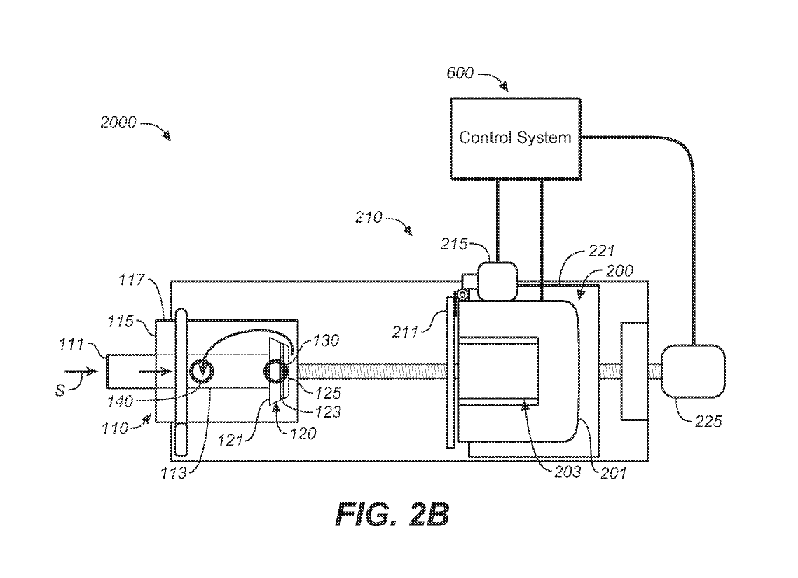

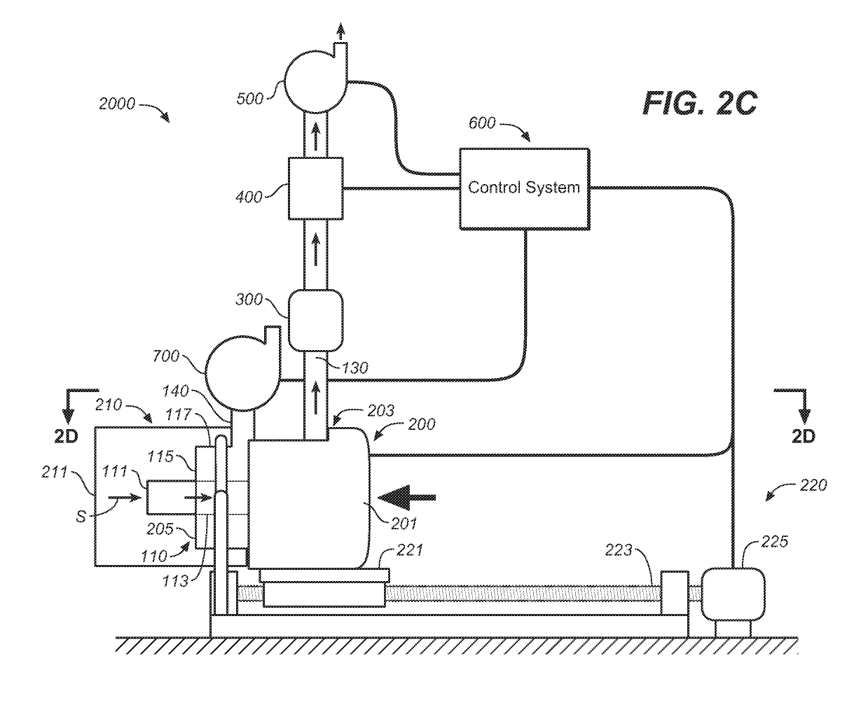

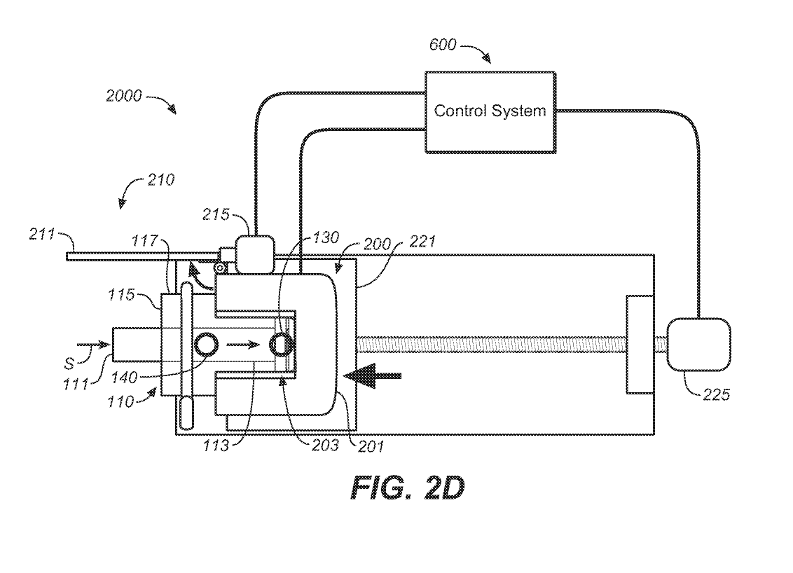

A second embodiment particle analysis system 2000 is illustrated in FIG. 2A as a side view particle analysis system in a first configuration, in FIG. 2B as a top view of the configuration of FIG. 2A, and in FIG. 2C is a side view of the a particle analysis system in a second configuration and in FIG. 2D as a top view of the configuration of FIG. 2C. Particle analysis system 2000 is generally similar to particle analysis system 1000, except as described below.

Particle analysis system 2000 includes an aspiration port 140 to draw air out from portion 113 using a high-volume pump 700. Pump 700 is operated by control system 600 in concert with pump 500 to provide flexibility in the operation of particle analysis system 2000.

In addition to be operated in a “laboratory mode,” as described above, particle analysis system 2000 may be operated in a “collection mode.” Thus, for example, a fresh filter 123 is provided to particle analysis system 2000 in a first configuration of FIGS. 2A and 2B, and pump 600 is activated, drawing the sample air stream S through inlet 111, through filter 123, and out of aspiration port 140 to the pump 700, as indicated by the arrows. In this way, air containing suspended particles is drawn through filter 123 for a known duration, and the particles are trapped by the filter. At the end of the sampling period, pump 700 is stopped and pump 500 is started.

Particle analysis system 2000 is then placed, by control system 600, into an “analysis mode” provided by the second configuration of FIGS. 2C and 2D. This mode of operation is similar to that described above with reference to FIGS. 1C and 1D.

When combustion of the particulates is complete, heater 200 is retracted, panel 211 is moved back into place, and sample chamber 110 is allowed to cool.

Particle analysis system 2000 may thus provide for the continuous, automatic analysis of the carbon content of particles in the sampled air stream, which may be the ambient atmosphere; a combustion exhaust stream such as the discharge from an engine or smoke plume; or other atmosphere for which the determination of the concentration of carbonaceous particles is required.

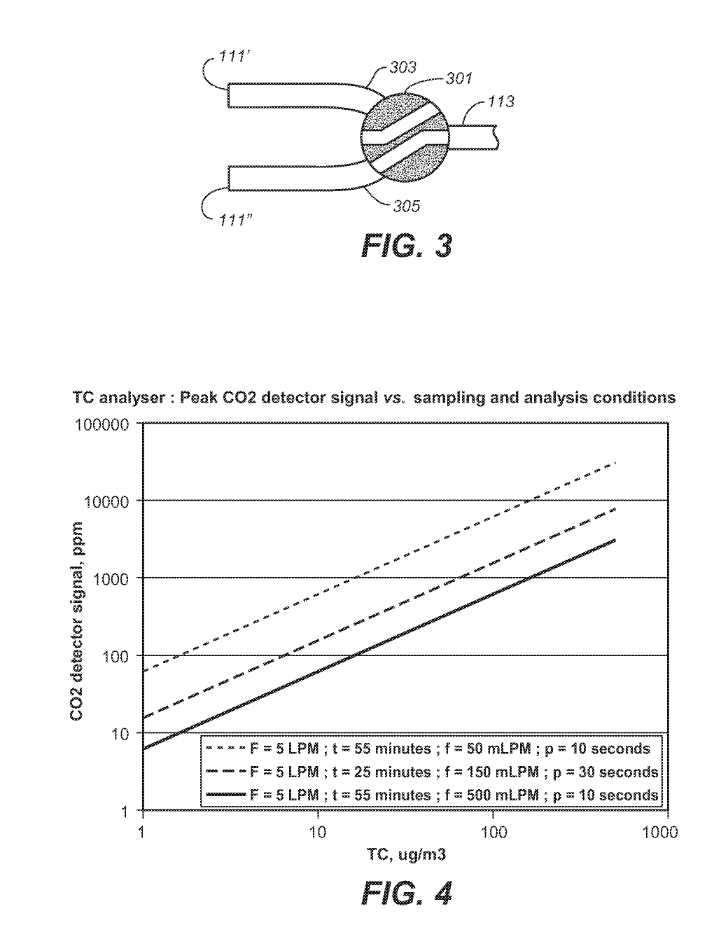

FIG. 3 is an alternative embodiment of a gas inlet of a particle analysis system 1000 or 2000. As illustrated in FIG. 3, tube 113 is coupled, through valve 301 operated by control system 600, to a first tube 303 having an opening 111′ and a second tube 305 having an opening 111″. In one embodiment, first tube 303 may provide gas S from opening 111′ for sample collection (as in FIGS. 2A and 2B), and second tube 305 may provide gas S from opening 111″ for a sample analysis (as in FIGS. 2C and 2D). Thus, for example tube 303 may collect gas from an occupational work environment, a combustion gas, or even from a gas that does not contain sufficient oxygen to support combustion. Tube 303 may collect gas from the ambient air, which may be, for example and without limitation, unfiltered air.

### Operational Considerations

As an example of a particle analysis system 1000 or 2000, consider the analytical performance requirements to yield meaningful data from a particulate sample containing from 10 micrograms to 100 milligrams of carbon. As a comparison, prior art systems typically heat samples in the size range of 10 to 100 micrograms over a duration on the order of 2000 seconds, thus releasing carbon to the flowing carrier gas stream at a rate of 5 nanograms per second. Since air contains approximately 535 nanograms of carbon per liter, very pure carrier gases are required to measure the extremely small carbon release from the sample.

The system described herein, such as particle analysis system 1000 or 2000, provides very rapid heating and combustion of a particulate sample in slowly-flowing stream of carrier gas, which gas may be the ambient air of the instrument's surroundings. If the above-mentioned sample of 10 micrograms carbon content is rapidly combusted in 10 seconds, the rate of carbon release into the flowing carrier gas stream will be 1 microgram per second. If the geometry of the combustion chamber is such that this effluent may be effectively entrained in a flowing stream of 0.05 LPM (0.83 milliliters per second), for example, the transient increase in CO₂ concentration in that stream will be (1/0.83) μg/mL=1.2 mg/L. Since 1 PPM CO₂ represents 0.535 μg/L, the concentration derived from the rapid combustion results in a transient increase in CO₂ of 2242 PPM over a period of 10 seconds. This increase in concentration of CO₂ can be immediately detected by a sensor whose sensitivity requirements are far less stringent than the requirements of existing instruments of the prior art. More importantly, the increase of 2242 PPM can be readily detected if superimposed on a baseline of 400 to 600 PPM CO₂ as is typically present in an ambient-air sampling environment. This increase is so large, relative to the ambient baseline, that we may use the proximal end-points before and after the CO₂ pulse event derived from the rapid combustion, with little overall error introduced if those end-points are inaccurate by a few PPM of CO₂. The highly significant consequence of this is that ambient air may be used as the carrier gas in this analysis. Specialty carrier gases of precise, known composition and purity are not required.

The above calculation assumed complete combustion of the sample in ten seconds. This effectively requires that the sample be heated from room to combustion temperature within only one or two seconds. Transmission of energy by electromagnetic radiation (in this case, radiant infra-red heat) is one preferably means for heating. However, the source of radiant heat should be at full intensity as soon as the analytical phase begins. It is inconvenient, though not impossible, to start from cold, and to dissipate very large quantities of electrical power in a heating element in order to bring that element from cold (room temperature) up to combustion temperatures in one or two seconds. It is an advantage of the present design that the heat-transfer element (the oven 200) is pre-heated to a high temperature before the analytical phase begins.

### Ability of System to Change Sensitivity:

In certain embodiments, the carrier gas stream provided by pump 500 into which the combustion products are released (in the second configuration of FIGS. 1C and 1D or 2C and 2D, for example), may flow at a rate that can be varied or controlled by control system 600 according to known or predictable parameters of the sample under analysis. Thus, for example, if the analytical carrier gas stream flow rate of the second configuration is small, the decomposition of a certain mass of carbon in the sample will lead to a higher transient concentration increase of CO₂ in the analytical carrier gas stream. If the analytical carrier gas stream flow rate is increased to a larger value, this same sample combustion will lead to a lower transient concentration increase in CO₂. Provided with foreknowledge of the likely sample mass of carbon, the flow rate of the analytical carrier gas stream provided by pump 500 may be varied by control system 600 to optimize the magnitude of the anticipated transient increase in CO₂. Since the CO₂ detector responds to concentration rather than flow, its ability to detect a certain concentration will not be affected by a change in carrier gas stream flow rate: however, the ability to change the flow rate allows the instrument to increase or decrease its sensitivity according to anticipated requirements.

The pulse of combustion products converted to CO₂ is not instantaneous, due to the finite rate of heating of the sampling chamber when the oven is moved over it. It is further spread out in time before reaching the detector due to the finite volume of the connecting tubing and the analytical volume of the detector itself. The minimum value of pulse duration that would be observed if the carbonaceous material combusted instantaneously, would be on the order of [system volume]/[analytical flow rate]. The internal volume of the analytical chamber could be on the order of 4 mL; adding the internal volumes of connecting tubing and the CO₂ detector gives total internal volume on the order of 10 mL. For analytical flow rates of 1 to 10 milliliters per second (50 to 500 mLPM), the pulse duration transit time will range from 1 to 10 seconds. Adding the heat transfer time of a few seconds leads to combustion product pulse duration minima estimates from 5 to 15 seconds.

Typical ambient concentrations of Total Carbon (TC) content of suspended particles in the atmosphere range from 1 to 100 μg/m³ in developed countries: higher concentrations may be measured in developing countries or in situations specifically impacted by direct combustion emissions. These particles are collected on the filter by the passage of air, and the filter is then analyzed. We can estimate the resultant CO₂ detector response as follows:

Denote the Total Carbon concentration as [TC] μg/m³ (or, equivalently, ng/liter). Denote the sample collection flow rate as [F] liters per minute, and the sample collection time as [t] minutes. Then total amount of TC collected in nanograms will then be

[C]=[TC]·[F]·[t] in nanograms

If the products of combustion to CO₂ were uniformly dispersed in 1 liter of air after combustion, this would give rise to a concentration increase:

ΔCO₂=[C]/535=[TC]·[F]·[t]/535ppm

Assume (for the simplistic purposes of this order-of-magnitude estimate) that the combustion products move in the analytical flow stream as a square-wave pulse. When this square pulse of increased CO₂ concentration passes through the detector, the detector output rises from ambient baseline [B] ppm by a signal response amount of [S] ppm. Denote the analytical flow rate [f] in milliliters per minute, and the combustion pulse duration [p] in seconds. Then:

$$\begin{matrix}[ S ] = Δ {CO}_{2} / \{ Analytical Flow Volume \} \\ = Δ {CO}_{2} / \{ [ F \} \cdot [ p ] / 1000 \cdot 60 \} \\ = \{ [ TC ] \cdot [ F ] \cdot [ t ] / 535 \} / \{ [ f ] \cdot [ p ] / 1000 \cdot 60 \} \\ = 112 \{ [ TC ] \cdot [ F ] \cdot [ t ] / [ f ] \cdot [ p ] \}\end{matrix} \qquad [ Equation 1 ]$$

The CO₂ detector signal increase is linearly proportional to the [TC] concentration, the sampling flow rate [F] and the sample collection time [t]. It is inversely proportional to the analytical flow rate [f] and the combustion pulse duration [p].

FIG. 4 shows the response of the CO₂ detector to a square pulse of combustion products, calculated from Equation 1 as a function of actual [TC] concentration for a realistic range of sampling and analytical conditions: Sample collection flow rate F liters per minute, set to 5 LPM; Sample collection time t minutes, either 25 or 55 minutes; Analytical flow rate f milliliters per minute, from 50 to 500 mLPM; and Combustion product pulse duration p seconds, either 10 or 30 seconds.

The calculations show that the characteristic peak height in CO₂ detector output would be from about 20 to 60 ppm at [TC]=1 μg/m³, rising to about 3000 to 30000 ppm for [TC]=300 μg/m³. These concentrations are easily detected by a simple CO₂ detector and can be resolved above the ambient background of typically 400 ppm. By controlling the analytical flow rate f, the instrument can automatically optimize its sensitivity and range, as described in the following section.

The sensitivity of the analyzer may thus be controlled over a wide range by controlling the flow rate of the analytical carrier gas stream during the combustion phase automatically and in real time by the coupling of data from other, co-located real-time measuring instruments.

### Coupling of Analyzer to Other Data Predictors for Dynamic Range Adjustment

The above analysis estimates the peak response of the CO₂ detector to be proportional to the sampled TC concentration, with all other sampling and analytical parameters are held constant. However, actual ambient concentrations of any measured aerosol parameter vary greatly according to location, meteorology, season and time of day. This is always observed in measurements of Black Carbon particulates, for example in diurnal cycles in urban locations or annual cycles at remote locations. A detector with sufficient sensitivity to resolve data at low concentrations could become overloaded at another time when concentrations may have increased by one or two orders of magnitude.

This may be a concern for analyzing pre-collected samples (“Laboratory mode”); and when collecting and analyzing samples continuously (“Field analyzer mode”).

In “Laboratory mode”, other information about the sample may be input to the system to assist in deciding the analytical operational parameters. This information could be numerically detailed; or it could be as simple as classification of the sample loading as “light”, “medium” or “heavy”.

In “Field Analyzer mode”, the sampling flow rate [F] will be fixed by station considerations and the selection of a suitable size-selective inlet. The combustion pulse duration [p] will be fixed by the heating parameters and the internal geometry of the analyzer plumbing. The data reporting time base will be fixed by station considerations: but the actual sampling and analysis time base could be shortened to a sub-multiple of this, if a longer collection time would result in an overload of collected material. Thus, if data reporting was required on a 1-hour time base, the analyzer could operate on three cycles of 20 minutes' collections if the average [TC] was very high. Finally, the analytical flow rate [f] can be varied at will without affecting or compromising the result in any way, provided that [f] is internally measured and actively controlled and stabilized. A hundred-fold variation in [f] from 50 mLPM to 5 LPM, stabilized under internal control, allows the analyzer to change its response by a factor of 100. The analyzer control system could be interfaced to data from other instruments, whose outputs could suggest whether the anticipated concentration of carbon particles was likely to be very high, or very low. With even only approximate guidelines, the analyzer analytical flow rate can be set to a value leading to either higher or lower sensitivity of the overall system, in such a way as to anticipate the likely magnitude of the result and attempt to operate the analyzer in an optimum range.

### Example

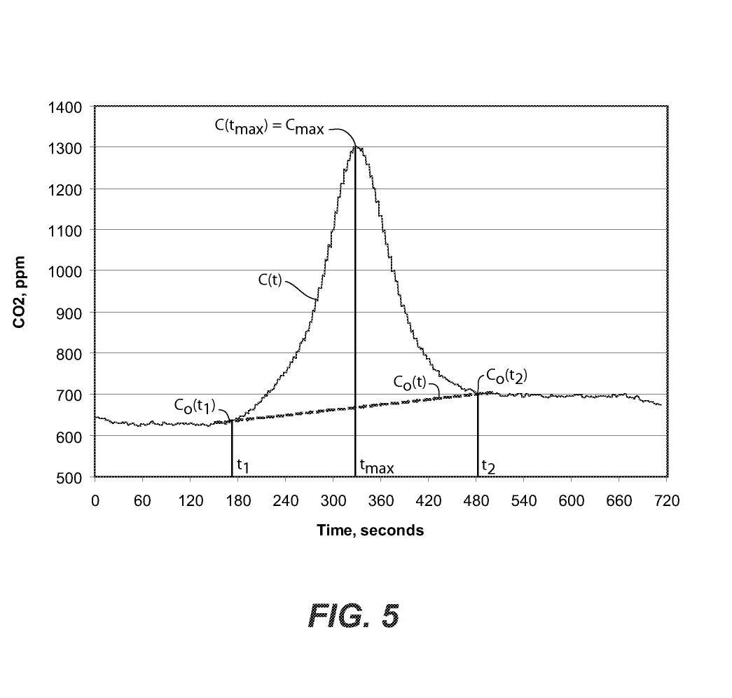

FIG. 5 presents data obtained to illustrate the output from a carbon dioxide detector 400 of a prototype particle analysis system 1000. It was determined independently that filter 123 included 75 micrograms of carbon particulates. FIG. 5 shows a measured CO₂ concentration, C(t), for a filter that was heated and where combustion of the particulates occurred in the presence of air over approximately 5 minutes, from a time t₁ to a time t₂. The dashed line shows the calculated baseline that increased from 630 ppm at time t₁ to 700 ppm at time t₂.

The increase in CO₂ concentration over ambient baseline is evident. The amount of CO₂ in excess over that baseline was integrated according the equation discussed above, to give a calculated carbon content of about 64 micrograms. This is approximately 85% of the independently measured amount of 75 micrograms. The prototype apparatus did not have a catalyst to provide complete conversion to CO2, and also heated the sample very slowly, so the operation the prototype particle analysis system was deemed very encouraging.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby expressly incorporated into this description, with each claim standing on its own as a separate embodiment of this invention.

We claim:

1. A method of determining the amount of carbon in a sample of particles, said method comprising:
collecting the particles from a first gas;
heating the collected particles in the presence of a second gas to generate a sample;
providing the sample to an analyzer capable of measuring the carbon content of the sample, where said second gas includes carbon dioxide detectable by the analyzer; and
providing an output from said analyzer indicative of the amount of carbon in the collected particles.

2. The method of claim 1, wherein said collecting collects the particles on a filter.

3. The method of claim 1, wherein said second gas is unpurified ambient air.

4. The method of claim 1, wherein said first gas and said second gas have the same composition.

5. The method of claim 1, where said providing provides in less than 15 seconds.

6. A method of determining the amount of carbon in a sample of particles contained in a gas sample, said method comprising:
collecting the particles from a first gas;
heating the collected particles in the presence of a second gas to generate a gaseous sample, where said second gas is unfiltered air or said first gas;
providing the sample to an analyzer capable of measuring the carbon content of the sample; and
providing an output from said analyzer indicative of the amount of carbon in the collected particles.

7. The method of claim 6, wherein said collecting collects the particles on a filter.

8. The method of claim 6, wherein said first gas is air.

9. The method of claim 6, wherein said first gas and said second gas have the same composition.

10. The method of claim 6, where said providing provides in less than 15 seconds.

11. The method of claim 6, where said air or the sample gas includes carbon dioxide detectable by the analyzer.

12. A method of determining the amount of carbon in a sample of particles, said method comprising:
collecting the particles from a first gas;
heating the collected particles in the presence of a second gas to generate a sample;
providing the sample to an analyzer in less that 15 seconds, where said analyzer is capable of measuring the carbon content of the sample; and
providing an output from said analyzer indicative of the amount of carbon in the collected particles.

13. The method of claim 12, where said second gas includes carbon dioxide detectable by the analyzer.

14. The method of claim 12, wherein said collecting collects the particles on a filter.

15. The method of claim 12, wherein said second gas is unfiltered air.

16. The method of claim 12, wherein said first gas and said second gas have the same composition.

17. A method of determining the amount of carbon in a sample of particles, said method comprising:
collecting the particles from a first gas;
heating the collected particles in the presence of a second gas to generate a sample;
varying the flow rate of said second gas according to the total amount of collected particles;
providing the sample to an analyzer capable of measuring the carbon content of the sample; and
providing an output from said analyzer indicative of the amount of carbon in the collected particles.

18. The method of claim 17, wherein said collecting collects the particles on a filter.

19. The method of claim 17, wherein said second gas is unfiltered air.

20. The method of claim 17, wherein said first gas and said second gas have the same composition.

21. An apparatus for determining the amount of carbon in a sample of particles, said apparatus comprising:
a filter for collecting particles;
a pump to provide a flow of unfiltered air to the collected particles;
a heater to heat the collected particles such that the particles combust in the unfiltered air;
a carbon dioxide detector to measure carbon dioxide in the combusted particles; and
a computer programmed to utilize the carbon dioxide detector output to provide an indication of the carbon contents of the collected particles.

22. The apparatus of claim 21, further including a catalyst between said heater and said carbon dioxide detector to provide complete conversion of carbon-containing products of the combusted particles to carbon dioxide.

23. The apparatus of claim 21, where said heater includes an electrically powered furnace and wherein said heater is movable to rapidly heat said collected particles.

24. The apparatus of claim 21, where said pump is a first pump, and further including a second pump to provide a flow of particulate-containing gas for collection of the particulate to the filter.

25. The apparatus of claim 21, where said filter is disposed within on a quartz tube.

26. The apparatus of claim 21, where said filter is disposed within a quartz container, and wherein said heater radiatively heats the collected particles.

27. The apparatus of claim 26, wherein said quartz container includes an inlet to provide gas to said filter, and a valve to provide a selectable gas source to said inlet.

28. The apparatus of claim 27, wherein said selectable gas source is selectable between unfiltered air and a particulate containing gas.

29. An apparatus to determine the content of carbon-containing particles in an air stream, said apparatus comprising:
means to combust the particles in the presence of unfiltered air; and
a carbon-dioxide sensor to measure a concentration of carbon-dioxide from the combusted particles.

30. The apparatus of claim 29, wherein said particles are collected on a filter, wherein said means to combust the particles includes an electrically heated furnace having an interior heated surface, and further including means for moving said furnace closer to said filter.

31. The apparatus of claim 29, where said filter is disposed within on a quartz tube.

32. The apparatus of claim 30, where said filter is disposed within a quartz container, and wherein said heater radiatively heats the collected particles.
